(19) United States
(12) Patent Application Publication
(10) Pub. No.: US 2024/0200002 A1
(43) Pub. Date: Jun. 20, 2024

(54) LIQUOR PACKAGE, RAW LIQUOR PACKAGE ASSEMBLY, AND LIQUOR MIXING METHOD

(71) Applicant: Zhejiang Geely Holding Group Co., Ltd, Hangzhou (CN)

(72) Inventor: Shufu LI, Hangzhou (CN)

(73) Assignee: Zhejiang Geely Holding Group Co., Ltd., Hangzhou, ZJ (CN)

(21) Appl. No.: 18/552,444

(22) PCT Filed: May 25, 2022
(86) PCT No.: PCT/CN2022/094946

§ 371 Date: Sep. 26, 2023

(30) Foreign Application Priority Data
Jul. 20, 2021 (CN) 202110817885.4

(51) Int. Cl. C12G 3/06; B01F 33/25; B65D 1/04; B65D 23/14; B65D 77/06; B65D 81/32; B65D 85/72; G06Q 10/087; G06Q 30/0282; G06Q 30/0601; G06Q 50/00; B01F 101/16

(52) U.S. Cl. CPC C12G 3/06; B01F 33/251; B65D 1/04; B65D 23/14; B65D 77/06; B65D 81/3211; B65D 85/72; G06Q 10/087; G06Q 30/0282; G06Q 30/0633; G06Q 50/01; B01F 2101/16; B65D 2577/042

(57) ABSTRACT

The present application relates to the technical field of liquor sets, and specifically relates to an unblended liquor and assembly convenient for liquor mixing, and a liquor mixing method for improving liquor tasting culture. The unblended liquor convenient for liquor mixing comprises a liquor bottle. The upper portion of the inner cavity of the liquor bottle is a liquor mixing cavity, wherein the liquor mixing cavity is used for providing an expansion space for a drinker to perform liquor mixing as desired, and for accommodating liquor mixing liquids. The lower portion of the inner cavity of the liquor bottle is an unblended liquor cavity, wherein unblended liquor is packaged in the unblended liquor cavity. The outer sidewall of the liquor bottle is circumferentially provided with at least one set of liquor mixing scales.

### TECHNICAL FIELD

The present application relates to the technical field of liquor sets, and in particular to a raw liquor and assembly convenient for liquor mixing, and a liquor mixing method for improving liquor tasting culture.

### BACKGROUND

With continuous development of society, people's life quality has been greatly improved. In festivals and activities such as various gatherings, the use rate of liquor becomes higher and higher, and people are constantly pursuing high-quality and flavorful raw liquor, which is becoming more and more popular.

Cocktails mixed with good flavors are also becoming increasingly popular, and it is possible customize one's own desired base liquor and various types of drinks on a personal basis. However, there is no concept of cocktail takeout in bars. On the one hand, it is inconvenient; and on the other hand, there are too many types of drinks and alcohol that are not suitable for takeout. Most cocktail consumers like the atmosphere of nightclubs, especially the mixing process of professional bartenders. However, it is a big regret for some people who want to drink unique cocktails during outdoor activities or gatherings.

In a banquet process in the prior art, it is often used to showcase expensiveness of liquor or specialty of the liquor, and in the drinking process, competition is made based on only the amount of drinking liquor. However, tasting for fine liquor's own flavor and unique quality is often overlooked, the entire wine culture ultimately turns into drinking competition culture, and taste culture and attributes of liquor is completely lost.

For consumers who truly love liquor and enjoy tasting liquor, it is a glorious thing to blend fine liquor with different flavors or tastes and share them with everyone. However, in order to meet requirements of standardized production, in the existing market and distilleries, all liquors are uniformly mixed according to standards. The entire mixing standard is evaluated by technical experts in distilleries, and the entire mixing process departs from consumers' actual liquor tasting needs and liquor tasting culture; that is, ordinary consumers is deprived of the opportunity of liquor mixing according to their liquor tasting preferences, and there is also a problem that grading division lacks consumption basis. It is unable to meet the current social's need for personalization requirement and improvement of liquor tasting culture.

Based on the shortcomings existing in the prior art, it is urgently required to research raw liquor and assembly convenient for liquor mixing, and a liquor mixing method for improving liquor tasting culture to solve the above problems.

### SUMMARY OF THE DISCLOSURE

According to embodiments of the present application, a raw liquor convenient for liquor mixing is provided, it comprises: a liquor bottle; wherein an upper portion of an inner cavity of the liquor bottle is a liquor mixing cavity, the liquor mixing cavity is configured to provide an expansion space for self-service liquor mixing for drinkers and accommodate liquor mixing liquid; a lower portion of the inner cavity of the liquor bottle is a raw liquor cavity, raw liquor liquid is packaged in the raw liquor cavity; an outer sidewall of the liquor bottle is circumferentially provided with at least one set of liquor mixing scales.

Furthermore, the raw liquor liquid is made by fermenting and distilling brewing raw materials in a specific cellar, without undergoing blending or mixing processes; the specific cellar is one of multiple brewing fermentation cellars with different taste or flavor levels.

Another aspect of the present application further protects a raw liquor assembly convenient for liquor mixing, which comprises a packaging box, wherein the packaging box is provided therein with at least one liquor mixing liquid bottle and at least one aforementioned raw liquor convenient for liquor mixing; the liquor mixing liquid bottle contains liquor mixing liquid and is configured to provide the liquor mixing liquid for liquor mixing to drinkers.

Furthermore, the liquor mixing liquid is liquor liquid, sugar liquid, seasoning liquid, or edible spice liquid.

Furthermore, the liquor liquid is mixed or blended liquor liquid that complies with national standards.

Furthermore, the liquor mixing liquid is distilled water.

Furthermore, raw liquor liquid in multiple raw liquors is packaged from the same brewing fermentation cellar.

Furthermore, raw liquor liquid in multiple raw liquors is packaged from multiple brewing fermentation cellar with different flavors and tastes.

Furthermore, a liquor mixing device is further included, the liquor mixing device comprises multiple liquor mixing balls or liquor mixing blocks of different volumes.

Furthermore, the liquor mixing device further comprises a tea bag with thread, and the tea bag contains the liquor mixing balls or the liquor mixing blocks.

Furthermore, the liquor mixing device is made of food grade stainless steel, and the liquor mixing blocks or the liquor mixing balls contain liquor mixing liquid with a constant volume.

Furthermore, the outer sidewall of the liquor bottle is provided with an identification piece, the identification piece has at least a cellar number identification, a cellar alcohol content identification, a flavor identification, and cellar grade information corresponding to the raw liquor liquid thereon.

Furthermore, the outer sidewall of the liquor bottle is further provided with a covering piece; the covering piece is removable from the outer sidewall of the liquor bottle, and the covering piece covers on the identification piece, such that the identification piece is invisible and a blind-box drinking style is formed.

Furthermore, the identification piece is provided with a digital identifier for scanning and identification by mobile terminals; the digital identifier is configured for a mobile terminal to scan and thereby connect to a cloud server of a distillery or supplier, and upload cellar information corresponding to the raw liquor liquid in the liquor bottle to the cloud server of the distillery or supplier, such that the cloud server of the distillery or supplier sends electronic gifts, electronic currencies, or prize information corresponding to the cellar information to the mobile terminal.

Another aspect of the present application further protects a liquor mixing method for improving liquor tasting culture, which uses the aforementioned raw liquor assembly convenient for liquor mixing. The method comprises: a cellar completing a brewing process and obtains raw liquor liquid that has neither been blended nor been mixed; measuring a degree of the raw liquor liquid of the cellar; canning the raw liquor liquid of the cellar; canning the raw liquor liquid of the cellar into multiple liquor bottles and sealing; dividing the sealed liquor bottles into packaging boxes and selling them to drinkers; the drinkers performing liquor mixing according to the liquor bottles or their own experience; after tasting liquor, the drinkers scanning digital identifications by mobile terminals and accessing an application; the drinkers performing evaluation according to the jumping application, and uploading liquor mixing solutions or uploading liquor mixing videos to a cloud server; alternatively, a plurality of drinkers simultaneously uploading liquor mixing solutions, conducting liquor mixing competitions, sharing liquor mixing solutions, and selling personal liquor mixing solutions, thereby forming a liquor mixing and liquor tasting culture community; according to the type of the cellar, the drinkers making online reservations for purchase quantities and generating cellar orders; the cloud server obtaining the cellar orders, matching them with personal liquor mixing solutions, and sending them to a distillery; the distillery performing packaging for the raw liquor assembly convenient for liquor mixing according to the cellar orders and the personal liquor mixing solutions; a consumer obtaining a raw liquor assembly sent by the distillery that meets a personalized liquor mixing taste thereof.

Furthermore, the drinkers, according to the type of the cellar and their own personal liquor mixing solutions or other personal liquor mixing solutions disclosed by a specified liquor mixing and liquor tasting culture community, make online reservations for purchase quantities and generate cellar orders matching with the personal liquor mixing solutions.

Furthermore, the liquor mixing method for improving liquor tasting culture is a liquor mixing method for a plurality of bottles of liquor of the same cellar in a packaging box.

Furthermore, the liquor mixing method for improving liquor tasting culture is a liquor mixing method for a plurality of bottles of liquor of different cellars in a packaging box.

Details of one or more embodiments of the present application are presented in the following drawings and description. Other features, purposes, and advantages of the present application will become apparent from the specification, drawings, and claims.

### BRIEF DESCRIPTION OF THE DRAWINGS

In order to explain technical solutions of the present application more clearly, drawings required to be used in description of the embodiments or of the prior art will be briefly introduced below. It is obvious that the drawings in the following description are only some embodiments of the present application. For one of ordinary skill in the art, other drawings can be further obtained according to these drawings on the premise of paying no creative work.

FIG. 1 is a structural view of a liquor containing assembly according to this embodiment.

FIG. 2 is a flow chart of a method for packaging a liquor containing device according to this embodiment.

11—liquor bottle; 12—sealing cover; 13—identification piece; 14—covering piece; 112—liquor mixing cavity, 113—raw liquor cavity; 141—first covering part; 142—second covering part; 143—tearable opening structure.

### DETAILED DESCRIPTION

The technical solutions in the embodiments of the present application will be described clearly and completely below in combination with the drawings in the embodiments of the present application. Obviously, the described embodiments are merely some embodiments of the present application, rather than all embodiments. Based on the embodiments of the present application, any other embodiment obtained by one of ordinary skill in the art on the premise of paying no creative work should belong to the protection scope of the present application.

It needs to be noted that the terms “first”, “second”, and the like in the specification, the claims, and the aforementioned drawings of the present application are used to distinguish similar objects, and need not be used to describe a specific sequence or order. It should be understood that data used in this way can be interchanged in appropriate cases, so that the embodiments of the present application described herein can be implemented in order other than those illustrated or described herein. In addition, the terms “include”, “have”, as well as any variations thereof, are intended to cover non-exclusive inclusion. For example, a process, method, system, product, or device that includes a series of steps or units need not be limited to those clearly listed steps or units, but may include other steps or units that are not clearly listed or inherent to these processes, methods, products, or devices.

The prior art has the following shortcoming: cocktails mixed with good flavors are also becoming increasingly popular, and it is possible customize one's own desired base liquor and various types of drinks on a personal basis. However, there is no concept of cocktail takeout in bars. On the one hand, it is inconvenient; and on the other hand, there are too many types of drinks and alcohol that are not suitable for takeout. Most cocktail consumers like the atmosphere of nightclubs, especially the mixing process of professional bartenders. However, it is a big regret for some people who want to drink unique cocktails during outdoor activities or gatherings.

Aiming the shortcoming in the prior art, the present application arranges a liquor mixing cavity and a raw liquor cavity communicating with each other, the raw liquor cavity is used to accommodate raw liquor that is neither blended nor mixed by a distillery bartender and directly canned from a cellar, and the liquor mixing cavity is used to accommodate liquor mixing liquid, such that drinkers can directly use the raw liquor as base liquor to perform liquor mixing in a liquor bottle, need not use additional liquor mixing devices, and can freely determine preparing time and drinking time of cocktail. There is no location restriction either, it is possible to mix various flavors at will using liquor containing assemblies, users' requirements are met, the structure is simple, and the operations are easy. At the same time, it is convenient to carry, such that the liquor mixing process is easier. Moreover, a covering piece is used to cover an identification piece, which is used to form a blind-box drinking style and increase fun of drinking.

### Embodiment 1

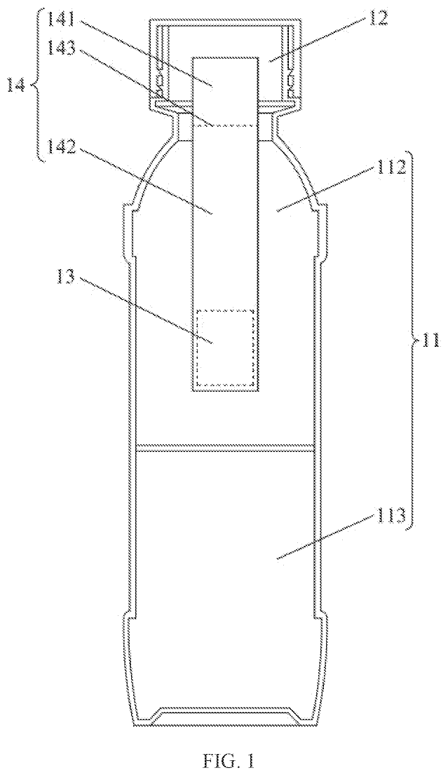

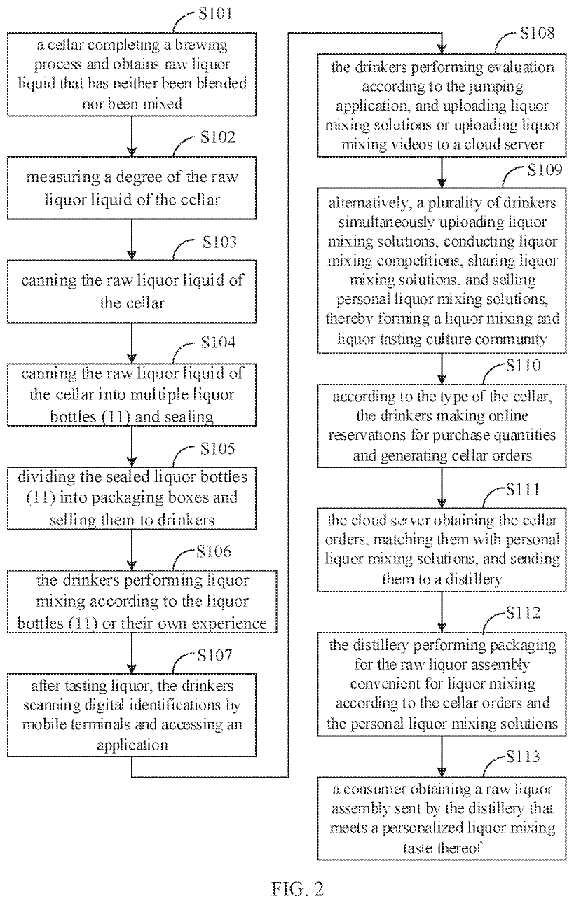

Referring to FIG. 1-FIG. 2, this embodiment provides a raw liquor convenient for liquor mixing, which includes a liquor bottle 11; an upper portion of an inner cavity of the liquor bottle 11 is a liquor mixing cavity 112, the liquor mixing cavity 112 is configured to provide an expansion space for self-service liquor mixing for drinkers and accommodate liquor mixing liquid; a lower portion of the inner cavity of the liquor bottle 11 is a raw liquor cavity 113, raw liquor liquid is packaged in the raw liquor cavity 113; an outer sidewall of the liquor bottle 11 is circumferentially provided with at least one set of liquor mixing scales.

It needs to be explained that the present application arranges the liquor mixing cavity 112 and the raw liquor cavity 113 communicating with each other, the raw liquor cavity 113 is used to accommodate raw liquor that is neither blended nor mixed by a distillery bartender and directly canned from a cellar, and the liquor mixing cavity 112 is used to accommodate liquor mixing liquid, such that drinkers can directly use the raw liquor as base liquor to perform liquor mixing in the liquor bottle 11, need not use additional liquor mixing devices, and can freely determine preparing time and drinking time of cocktail. There is no location restriction either, it is possible to mix various flavors at will using liquor containing assemblies, users' requirements are met, the structure is simple, and the operations are easy. At the same time, it is convenient to carry, such that the liquor mixing process is easier. Moreover, a covering piece 14 is used to cover an identification piece 13, which is used to form a blind-box drinking style and increase fun of drinking.

It needs to be further explained that in this embodiment, the liquor bottle 11 can not only hold liquor but also be used for liquor mixing, so that it is reused as a daily item in daily life, thereby saving resources to a certain extent.

Specifically, the liquor mixing scales are used to display an alcohol content after liquor mixing or used to display a volume of the liquor mixing liquid in the liquor bottle 11.

In some possible embodiments, the outer sidewall of the liquor bottle 11 is further provided with a set of liquor mixing graduation lines, the liquor mixing graduation lines are set along a height direction of the liquor bottle 11, and the liquor mixing graduation lines are used to display a volume of the liquor mixing liquid.

In some possible embodiments, a sidewall of the liquor bottle 11 is provided with a transparent window, the liquor mixing graduation lines are arranged on the transparent window, such that the volume of the liquor mixing liquid can be intuitively seen during liquor mixing, it is convenient to control a proportion of added liquid and thereby blend out liquor suitable for one's own taste.

In some possible embodiments, the raw liquor liquid is made by fermenting and distilling brewing raw materials in a specific cellar, without undergoing blending or mixing processes; the specific cellar is one of multiple brewing fermentation cellars with different taste or flavor levels.

Another aspect of the present application further protects a raw liquor assembly convenient for liquor mixing, which includes a packaging box, the packaging box is provided therein with at least one liquor mixing liquid bottle and at least one aforementioned raw liquor convenient for liquor mixing; the liquor mixing liquid bottle contains liquor mixing liquid and is configured to provide the liquor mixing liquid for liquor mixing to drinkers.

In some possible embodiments, the liquor mixing liquid is liquor liquid, sugar liquid, seasoning liquid, or edible spice liquid.

In some possible embodiments, the liquor liquid is mixed or blended liquor liquid that complies with national standards.

In some possible embodiments, the liquor mixing liquid is distilled water.

In this embodiment, the packaging box is provided therein with one liquor bottle 11 and one liquor mixing liquid bottle, liquid in the liquor mixing liquid bottle can be poured into the liquid bottle 11 to perform liquor mixing.

In some possible embodiments, the packaging box includes a plurality of first accommodation grooves and at least one second accommodation groove; the second accommodation groove is provided therein with the liquor mixing liquid bottle; each of the first accommodation grooves can be provided therein with a raw liquor, and a plurality of raw liquors in the packaging box can come from different cellars, such that a drinker can drink the raw liquors of multiple cellars, and it is easy to find raw liquor liquid suitable for the drinker's preference.

In some possible embodiments, raw liquor liquid in the multiple raw liquors is packaged from the same brewing fermentation cellar.

In some possible embodiments, raw liquor liquid in the multiple raw liquors is packaged from multiple brewing fermentation cellar with different flavors and tastes.

In some possible embodiments, a liquor mixing device is further included, the liquor mixing device includes multiple liquor mixing balls or liquor mixing blocks of different volumes.

In some possible embodiments, the liquor mixing device is a cylindrical casing, the tea bag with thread is placed in the cylindrical casing, and the liquor mixing balls or the liquor mixing blocks are placed in the tea bag with thread.

In some possible embodiments, the liquor mixing device further comprises a tea bag with thread, and the tea bag contains the liquor mixing balls or the liquor mixing blocks.

In some possible embodiments, the liquor mixing device is made of food grade stainless steel, and the liquor mixing blocks or the liquor mixing balls contain liquor mixing liquid with a constant volume.

In some possible embodiments, the outer sidewall of the liquor bottle 11 is provided with an identification piece 13; the identification piece 13 has at least a cellar number identification, a cellar alcohol content identification, a flavor identification, and cellar grade information corresponding to the raw liquor liquid thereon.

In some possible embodiments, the outer sidewall of the liquor bottle 11 is further provided with a covering piece 14; the covering piece 14 is removable from the outer sidewall of the liquor bottle 11, and the covering piece 14 covers on the identification piece 13, such that the identification piece 13 is invisible and a blind-box drinking style is formed.

Specifically, the identification piece 13 has at least a cellar number identification, a cellar alcohol content identification, a flavor identification, and cellar grade information corresponding to the raw liquor liquid thereon.

In some possible embodiments, the outer sidewall of the liquor bottle 11 is provided with two identification pieces 3, wherein one identification piece 13 is covered by the covering piece 14, the other identification piece 3 is not covered by the covering piece 4, and the uncovered identification piece 3 is provided with a digital identifier for scanning and identification by mobile terminals.

In some possible embodiments, the identification piece 13 is adhered on the outer sidewall of the liquor bottle 11, and the identification piece 13 is a paper label.

Furthermore, the covering piece 14 is removably connected to the liquor bottle 11, and the covering piece 14 covers on the identification piece 13, such that the identification piece 13 is invisible.

In some possible embodiments, the covering piece 14 is adhered on the identification piece 13; the covering piece 14 covers the identification piece 13 completely, the identification piece 13 cannot be seen, such that drinkers do not know the flavor of the raw liquor liquid, thereby forming a blind-box drinking style and increasing fun of drinking; the covering piece 14 is also a paper label.

Specifically, an adhesive force between the covering piece 14 and the identification piece 13 is less than an adhesive force between the identification piece 13 and the liquor bottle 11, such that the covering piece 14 can be torn off from the identification piece 13, while the identification piece 13 is still adhered on the liquor bottle 11.

Specifically, after the covering piece 14 is torn off from the identification piece 13, the covering piece 14 cannot be adhered to the identification piece 13 again, that is, the covering piece 14 cannot be reused. It can be avoided that the covering piece 14 is attached again after the raw liquor liquid is blended. The covering piece 14 that cannot be reused can ensure that the raw liquor liquid in the raw liquor is not blended.

In some possible embodiments, the covering piece 14 includes a first covering part 141, a second covering part 142, and a tearable opening structure 143 formed by prefabricated cut dashed lines; the tearable opening structure 143 is arranged at the connection between the first covering part 141 and the second covering part 142; the first covering part 141 is adhered and fixed to a sealing cover 12, and the second covering part 142 is adhered and fixed to the liquor bottle 11.

Specifically, each raw liquor is provided thereon with an identification piece 13 corresponding thereto.

In some possible embodiments, the identification piece 13 is provided with a digital identifier for scanning and identification by mobile terminals. The digital identifier is used for a mobile terminal to scan and thereby connect to a cloud server of a distillery or supplier, and upload cellar information corresponding to the raw liquor liquid in the liquor bottle 11 to the cloud server of the distillery or supplier, such that the cloud server of the distillery or supplier sends electronic gifts, electronic currencies, or prize information corresponding to the cellar information to the mobile terminal.

Specifically, the sealing cover 12 is further included, the sealing cover 12 is connected by thread to an opening end of the liquor bottle 11.

In some possible embodiments, the liquor bottle 11 includes a first partition plate and a second partition plate, the first partition plate and the second partition plate are arranged along an axial direction of the liquor bottle 11, and both an axis of the first partition plate and an axis of the second partition plate coincide with an axis of the liquor bottle 11.

Specifically, the liquor bottle 11 includes an upper cup body having the liquor mixing cavity and a lower cup body having the raw liquor body, the upper cup body is rotatably connected to the lower cup body, the first partition plate is fixedly connected to the upper cup body, and the second partition plate is fixedly connected to the lower cup body. The first partition plate is provided with a first through hole, the second partition plate is provided with a second through hole, the first partition plate is rotatable along with the upper cup body, such that the first through hole is in communication with the second through hole.

Another aspect of the present application further protects a liquor mixing method for improving liquor tasting culture, which uses the aforementioned raw liquor assembly convenient for liquor mixing. The method includes: S101, a cellar completes a brewing process and obtains raw liquor liquid that has neither been blended nor been mixed; S102, measuring a degree of the raw liquor liquid of the cellar; S103, canning the raw liquor liquid of the cellar; S104, canning the raw liquor liquid of the cellar into multiple liquor bottles 11 and sealing; S105, dividing the sealed liquor bottles 11 into packaging boxes and selling them to drinkers; S106, the drinkers perform liquor mixing according to the liquor bottles 11 or their own experience; S107, after tasting liquor, the drinkers scan digital identifications by mobile terminals and access an application; S108, the drinkers perform evaluation according to the jumping application, and upload liquor mixing solutions or upload liquor mixing videos to a cloud server; S109, alternatively, a plurality of drinkers simultaneously upload liquor mixing solutions, conduct liquor mixing competitions, share liquor mixing solutions, and sell personal liquor mixing solutions, thereby forming a liquor mixing and liquor tasting culture community; S110, according to the type of the cellar, the drinkers make online reservations for purchase quantities and generate cellar orders; Sll1, the cloud server obtains the cellar orders, matches them with personal liquor mixing solutions, and sends them to a distillery; S112, the distillery performs packaging for the raw liquor assembly convenient for liquor mixing according to the cellar orders and the personal liquor mixing solutions; S113, a consumer obtains a raw liquor assembly sent by the distillery that meets a personalized liquor mixing taste thereof.

In some possible embodiments, the drinkers, according to the type of the cellar and their own personal liquor mixing solutions or other personal liquor mixing solutions disclosed by a specified liquor mixing and liquor tasting culture community, make online reservations for purchase quantities and generate cellar orders matching with the personal liquor mixing solutions.

Specifically, the canning the raw liquor liquid in the cellar into multiple liquor bottles 11 and sealing includes: obtaining liquor information in a designated cellar, amount of liquor produced in the designated cellar, and a volume of the raw liquor liquid contained in the raw liquor; obtaining the number of the raw liquors that can be canned based on the volume of the raw liquor liquid contained in the raw liquor and the amount of liquor produced in the designated cellar; obtaining the identification pieces 13 having the liquor information based on the number of the raw liquors that can be canned and the liquor information, wherein the number of the identification pieces 13 is equal to that of the raw liquors; dividing the raw liquor liquid of the designated cellar into multiple raw liquors, arranging the identification pieces 13 on the raw liquors and sealing, thereby obtaining sealed raw liquors; dividing the sealed raw liquors into packaging boxes.

Specifically, after that a consumer obtains a raw liquor assembly sent by the distillery that meets a personalized liquor mixing taste thereof, the method further includes that: the distillery grades or optimizes the grading of cellars based on the number of orders.

That the distillery grades or optimizes the grading of cellars based on the number of orders includes that: a mobile terminal can evaluate the cellars by scanning the digital identifier on the raw liquors and based on the preferences of the drinkers, and sends an evaluation result to a distillery client or a cloud server; the distillery client or the cloud server grades or optimizes the grading of cellars based on the evaluation result and required amount; and sorts according levels of the cellars to obtain a cellar level ranking.

Specifically, the obtaining the number of the raw liquors that can be canned based on the volume of the raw liquor liquid contained in the raw liquor and the amount of liquor produced in the designated cellar includes: dividing the amount of liquor produced in the designated cellar by the volume of the raw liquor liquid contained in the raw liquor, the obtained integer is the number of the raw liquors that can be canned.

In some possible embodiments, after the dividing the sealed raw liquors into packaging boxes, the method further includes: obtaining the number of the raw liquors of the designated cellar that can be canned and the number of the raw liquors accommodated in one packaging box; dividing the number of the raw liquors of the designated cellar that can be canned by the number of the raw liquors accommodated in one packaging box to obtain the number of required packaging boxes.

In some possible embodiments, the liquor mixing method for improving liquor tasting culture is a liquor mixing method for a plurality of bottles of liquor of the same cellar in a packaging box.

In some possible embodiments, the liquor mixing method for improving liquor tasting culture is a liquor mixing method for a plurality of bottles of liquor of different cellars in a packaging box.

Although the present application has been described through preferred embodiments, the present application is not limited to the embodiments described herein and further includes various changes and variations made without departing from the scope of the present application.

In this specification, the involved positional terms, such as “front”, “back”, “up”, “down”, and the like are defined according to positions of components located in the figures and among the components in the accompany drawings, and are only for clarity and convenience of expressing technical solutions. It should be understood that the use of the positional terms should not limit the scope of protection requested in the present application.

In this specification, the above embodiments and features in the embodiments can be combined with each other in the situation of no conflict.

The above disclosure is only a preferred embodiment of the present application, and of course, it cannot be used to limit the scope of right of the present application. Therefore, equivalent changes made according to the claims of the present application still fall within the scope covered by the present application.

1. A raw liquor package comprising a liquor bottle; wherein an upper portion of an inner cavity of the liquor bottle is a liquor mixing cavity, the liquor mixing cavity is configured to provide an expansion space for self-service liquor mixing for drinkers and accommodate liquor mixing liquid; a lower portion of the inner cavity of the liquor bottle is a raw liquor cavity; an outer sidewall of the liquor bottle is circumferentially provided with at least one set of liquor mixing scales; wherein the raw liquor package further comprises raw liquor liquid packaged in the raw liquor cavity.

2. The raw liquor package according to claim 1, wherein the raw liquor liquid is made by fermenting and distilling brewing raw materials in a specific cellar, without undergoing blending or mixing processes; the specific cellar is one of multiple brewing fermentation cellars with different taste or flavor levels.

3. A raw liquor package assembly comprising a packaging box, wherein the packaging box is provided therein with at least one liquor mixing liquid bottle and at least one raw liquor package according to claim 1; the liquor mixing liquid bottle contains liquor mixing liquid and is configured to provide the liquor mixing liquid to drinkers for liquor mixing.

4. The raw liquor package assembly according to claim 3, wherein the liquor mixing liquid comprises at least one of auxiliary liquor liquid, sugar liquid, seasoning liquid, or edible spice liquid.

5. The raw liquor package assembly according to claim 4, wherein the auxiliary liquor liquid is mixed or blended liquor liquid that complies with national standards.

6. The raw liquor package assembly according to claim 4, wherein the liquor mixing liquid further comprises distilled water.

7. The raw liquor package assembly according to claim 3, wherein the packaging box is provided therein with multiple raw liquor packages, each of the raw liquor packages comprises a liquor bottle, an upper portion of an inner cavity of the liquor bottle is a liquor mixing cavity, the liquor mixing cavity is configured to provide an expansion space for self-service liquor mixing for drinkers and accommodate liquor mixing liquid, a lower portion of the inner cavity of the liquor bottle is a raw liquor cavity, an outer sidewall of the liquor bottle is circumferentially provided with at least one set of liquor mixing scales, the raw liquor package further comprises raw liquor liquid packaged in the raw liquor cavity, and the raw liquor liquid in the multiple raw liquors is packaged from the same brewing fermentation cellar.

8. The raw liquor package assembly according to claim 3, wherein the packaging box is provided therein with multiple raw liquor packages, each of the raw liquor packages comprises a liquor bottle, an upper portion of an inner cavity of the liquor bottle is a liquor mixing cavity, the liquor mixing cavity is configured to provide an expansion space for self-service liquor mixing for drinkers and accommodate liquor mixing liquid, a lower portion of the inner cavity of the liquor bottle is a raw liquor cavity, an outer sidewall of the liquor bottle is circumferentially provided with at least one set of liquor mixing scales, the raw liquor package further comprises raw liquor liquid packaged in the raw liquor cavity, and the raw liquor liquid in the multiple raw liquors is packaged from multiple brewing fermentation cellar with different flavors and tastes.

9. The raw liquor package assembly according to claim 3, further comprising a liquor mixing device, wherein the liquor mixing device comprises multiple liquor mixing balls or liquor mixing blocks of different volumes.

10. The raw liquor package assembly according to claim 9, wherein the liquor mixing device further comprises a tea bag with thread, and the tea bag contains the liquor mixing balls or the liquor mixing blocks.

11. The raw liquor package assembly according to claim 9, wherein the liquor mixing device is made of food grade stainless steel, and the liquor mixing blocks or the liquor mixing balls contain liquor mixing liquid with a constant volume.

12. The raw liquor package assembly according to claim 3, wherein the outer sidewall of the liquor bottle is provided with an identification piece; the identification piece has at least a cellar number identification, a cellar alcohol content identification, a flavor identification, and cellar grade information corresponding to the raw liquor liquid thereon.

13. The raw liquor package assembly according to claim 12, wherein the outer sidewall of the liquor bottle is further provided with a covering piece; the covering piece is removable from the outer sidewall of the liquor bottle, and the covering piece covers on the identification piece, such that the identification piece is invisible and a blind-box drinking style is formed.

14. The raw liquor package assembly according to claim 12, wherein the identification piece is provided with a digital identifier for scanning and identification by mobile terminals; the digital identifier is configured for a mobile terminal to scan and thereby connect to a cloud server of a distillery or supplier, and upload cellar information corresponding to the raw liquor liquid in the liquor bottle to the cloud server of the distillery or supplier, such that the cloud server of the distillery or supplier sends electronic gifts, electronic currencies, or prize information corresponding to the cellar information to the mobile terminal.

15. A liquor mixing method, which uses the raw liquor package assembly according to claim 3; wherein the method comprises: a cellar completing a brewing process and obtains raw liquor liquid that has neither been blended nor been mixed; measuring a degree of the raw liquor liquid of the cellar; canning the raw liquor liquid of the cellar; canning the raw liquor liquid of the cellar into multiple liquor bottles and sealing; dividing the sealed liquor bottles into packaging boxes and selling them to drinkers; the drinkers performing liquor mixing according to the liquor bottles—or their own experience; after tasting liquor, the drinkers scanning digital identifications by mobile terminals and accessing an application; the drinkers performing evaluation according to the jumping application, and uploading liquor mixing solutions or uploading liquor mixing videos to a cloud server; alternatively, a plurality of drinkers simultaneously uploading liquor mixing solutions, conducting liquor mixing competitions, sharing liquor mixing solutions, and selling personal liquor mixing solutions, thereby forming a liquor mixing and liquor tasting culture community; according to the type of the cellar, the drinkers making online reservations for purchase quantities and generating cellar orders; the cloud server obtaining the cellar orders, matching them with personal liquor mixing solutions, and sending them to a distillery; the distillery performing packaging for the raw liquor package assembly according to the cellar orders and the personal liquor mixing solutions; a consumer obtaining a raw liquor package assembly sent by the distillery that meets a personalized liquor mixing taste thereof.

16. The liquor mixing method according to claim 15, wherein the drinkers, according to the type of the cellar and their own personal liquor mixing solutions or other personal liquor mixing solutions disclosed by a specified liquor mixing and liquor tasting culture community, make online reservations for purchase quantities and generate cellar orders matching with the personal liquor mixing solutions.

17. The liquor mixing method according to claim 15, wherein the liquor mixing method is a liquor mixing method for a plurality of bottles of liquor of the same cellar in a packaging box.

18. The liquor mixing method according to claim 15, wherein the liquor mixing method is a liquor mixing method for a plurality of bottles of liquor of different cellars in a packaging box.
